(19) United States
(12) Patent Application Publication
(10) Pub. No.: US 2006/0133639 A1
(43) Pub. Date: Jun. 22, 2006

(54) Diaphragm for loudspeaker - magnesium alloy base and multi-layers ceramic structure

(75) Inventor: Wei-Chung Wu, Taipei (TW)

Correspondence Address: TROXELL LAW OFFICE PLLC, SUITE 1404, 5205 LEESBURG PIKE, FALLS CHURCH, VA, 22041, US

(73) Assignee: Meiloon Industrial Co., Ltd.

(21) Appl. No.: 11/014,168

(22) Filed: Dec. 17, 2004

(51) Int. Cl. H04R 9/06

(52) U.S. Cl. 381/426

(57) ABSTRACT

A diaphragm for loudspeakers comprises the magnesium base alloy as a substrate, in which the content of magnesium is over than 90% and the outer layers are porous oxide ceramic layers. The composite multi-layers structure of this magnesium base diaphragm is formed by the process of micro-arc plasma-electrolytic treatment (MAPET), an advanced environment-friendly electrolytic process. The outer multi-layers porous ceramic layers provide the function of corrosion protection for magnesium which is vulnerable to the general environment. The ceramic layers also improve the stiffniess of the diaphragm. With the combination of the stiffness improvement and excellent mechanical internal loss property from magnesium, the driver made of this multi-layers structure diaphragm are with the wider effective frequency response range and less distortion resulted from the partial vibration of the diaphragm.

### BACKGROUND OF THE INVENTION

1. Field of the Invention

The present invention relates to a loudspeaker diaphragm comprising a multi-layers composite structure. The substrate for the diaphragm is a magnesium base alloy in which the content of magnesium is over than 90%. By employing the process of micro-arc plasma-electrolytic treatment (MAPET), the porous ceramic oxide layers are created on the outer sides of magnesium base alloy and, then, a composite structure diaphragm is constructed.

2. Description of the Related Art

Loudspeaker diaphragms are used to convert electric vibration into mechanical vibration. The vibration of diaphragm radiates the sound wave by the media of air so that people can hear the sound in the audible range. Due to the direct contact with the air, the sound transmission media, diaphragm is a key factor in determining the audio quality in the design of the loudspeaker. The selection of material for the diaphragm depends on the desired dominant frequency range of the drivers. Various materials have been used in the construction of loudspeaker diaphragm. The commonly used materials in the audio industry are pulp, plastic, aluminum, titanium, etc.

The two major characteristics are usually considered in the selection of diaphragm material. One is the specific stiffness and the other is mechanical internal loss property (or referred as damping capacity). In terms of mechanical properties, the material with the property of higher stiffness has higher natural resonance frequency. For the diaphragm made of higher stiffness material, the partial vibrations during the diaphragm operation usually take place in higher frequency. The stiffness increase of the diaphragm will allow the driver to have a wider effective frequency response range. The mechanical loss property relates to the capacity of energy absorbing when partial vibration is acting. This property could eliminate the distortion caused by the partial vibration of the diaphragm. The more flat response curve on the frequency response chart could be measured if the driver is constructed by using the diaphragm made of high damping capacity material.

The typical commonly used diaphragm materials in the audio industry can hardly keep two characteristics mentioned above at the same time. For instance, the cone made of pulp is with the good mechanical internal loss and, however, the stiffness is relatively low. Thus, the range of effective frequency response is restricted. Relatively, the cone made of metal, such as aluminum or titanium, possesses the better stiffness property and, however, the damping capacity of these metal is generally inferior to the pulp or polypropylene cones. The deformation and the partial vibration are obvious during the diaphragm operation and, result in the apparent mechanical distortion in a certain frequency domain.

In the applicable metal materials for loudspeaker diaphragm, magnesium has been viewed as an ideal material for the application of the diaphragm due to its excellent mechanical internal loss property and stiffness. Magnesium has the lowest specific density (the specific density: 1.8) and the best stiffness, comparing with 2.7 of aluminum and 4.5 of titanium. In the criteria to select the material for high-end loudspeaker, the damping capacity for magnesium far surpasses the aluminum and titanium. (Referring to the chart below).

[image]

Although magnesium possesses two major excellent characteristics for the selection of diaphragm material-damping capacity and stiffness, the major barrier to successfully commercialize the magnesium base alloy in the application of diaphragm is that magnesium is vulnerable to corrosion, which means that adequate protection is required. Besides, as a role for radiating the sound wave during the process of continuous vibration of the diaphragm, the bonding adhesion between the protection layer and magnesium base alloy is another key factor in developing magnesium as loudspeaker diaphragm.

The present invention comes up with a multi-layers composite structure for magnesium base alloy diaphragm by studying the treatment technology.

### SUMMARY OF THE INVENTION

The present invention has been developed to construct a multi-layers structure diaphragm by employing the process of micro-arc plasma-electrolytic treatment. The substrate for the diaphragm is Magnesium base alloy in which the content of Magnesium is over than 90%. During the treatment process, the layer of oxide ceramic that is produced grows outward. The thickness of oxide ceramic layers in each side of the substrate is between 5 and 25 micron, determined by the reacting time during the process.

The oxide ceramic layers provide the prevention function from the corrosion in the environment and, also, further increase the stiffness of the diaphragm. With the excellent mechanical internal loss and enhanced stiffness properties, the driver constructed by the diaphragm from the invention herein, is with the wider effective response and higher fidelity in reproduction. The present invention is an ideal selection for diaphragm, especially in the hi-end products.

The above objects, features and advantages of the present invention will become apparent from the following detailed description taken with the accompanying drawing. However, these drawings are provided for reference and illustration and not intended to act as a limitation to the present invention.

### BRIEF DESCRIPTION OF THE DRAWINGS

FIG. 1 is a perspective view of a typical loudspeaker cone assembly of the present invention.

FIG. 2 is a graph illustrating a formed magnesium diaphragm prior to the process of MAPET. Metal gloss can be detected.

FIG. 3 is a cross sectional of an embodiment of the invention after MAPET process.

FIG. 4 is a graphic representation for the different oxide ceramic layers/metal bonding FIG. 5 is to illustrate the diaphragm appearance after MAPET, typically a foggy gray-white color

### DETAILED DESCRIPTION OF THE PREFERRED INVENTION

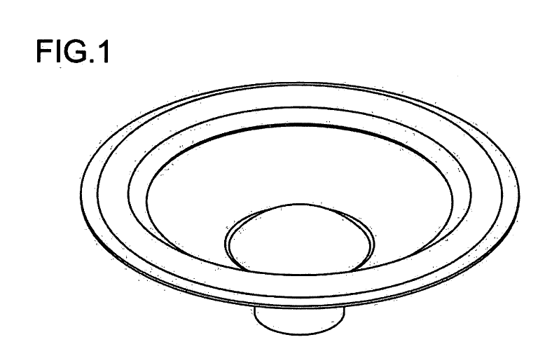

Referring to FIG. 1, a typical speaker cone assembly of the present invention is shown. The loudspeaker diaphragm of the present invention substantially comprises a magnesium base alloy as a substrate and oxide ceramic outer layers, becoming a multi-layers structure diaphragm. The magnesium content of substrate is over than 90%. The shape of the diaphragm is formed by the special press operation which requires heating to a certain temperature supporting the transformation of magnesium alloy to a formable state. Although the configuration of the diaphragm of the embodiment according to the present invention is cone-shape, dome-shape may also be applicable.

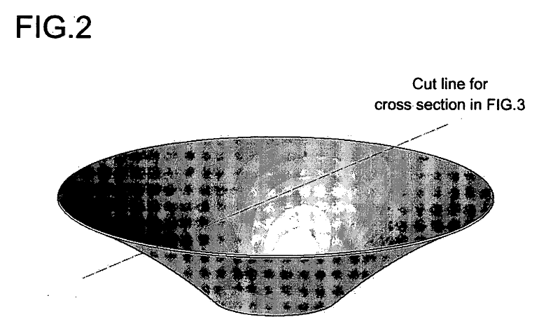

FIG. 2 is a formed magnesium base alloy diaphragm. The metal gloss can be detected if the raw metal foil is through the acid-cleaned process prior to the process of MAPET.

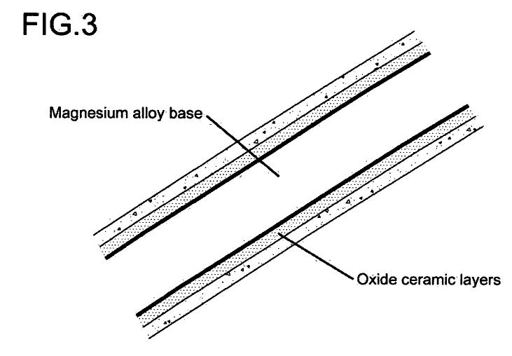

Next, a micro-arc plasma-electrolytic treatment (MAPET) will be described. MAPET is an electrolytic process, which makes use of an external power source and the environment-friendly saline solutions, different from the one in conventional anodizing process. MAPET process is used to produce oxide ceramic layers, which, in addition to providing a high level of protection agent against corrosion, also fulfill the stiffniess reinforcement of the diaphragm. A formed diaphragm workpiece acts as the anode in the treatment bath. The surface material is transformed into the corresponding oxides through the MAPET process. The electrolytes used are specific kind of saline solutions which are environment-friendly solutions. Anodizing takes place as the plasma is discharged in the electrolyte on the surface of the formed diaphragm. The effect of the oxygen plasma produced in the electrolyte on the metal surface causes partial short-term surface melting and the end result is an adherent compound layers of oxide ceramic and metal on the surface of the formed speaker diaphragm. The layer of oxide ceramic that is produced grows outward over the reacting time in the process of MAPET. The growth thickness for oxide ceramic layer is determined by the plasma reacting time and the composition of magnesium based alloy. FIG. 3 is a cross sectional view of an embodiment of the invention.

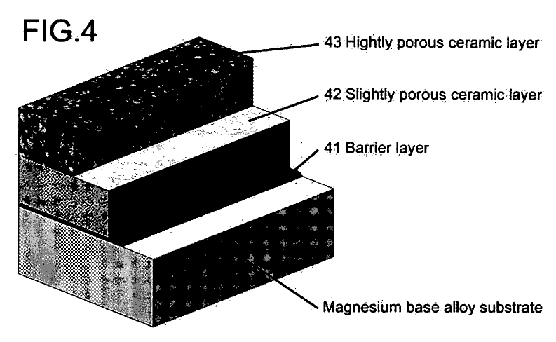

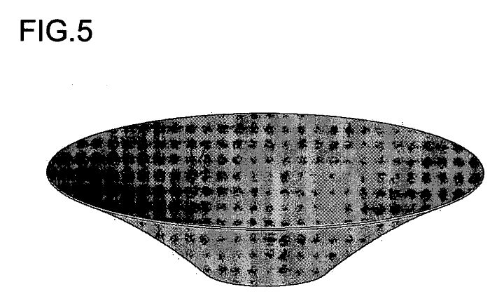

FIG. 4 is the graphic representation of the oxide ceramic/metal bonding. There are three layers in each side of the substrate, a thin barrier layer 41, a slightly porous ceramic layer 42 and a highly porous ceramic layer 43. The thin barrier layer is in direct contact with the magnesium base substrate. The two porous ceramic layers are built up on a barrier layer.

After MPET process, the magnesium base alloy diaphragm turns out to be a multi layer composite structure. The chemical composition of the layers contains a large proportion of highly reinforcing ceramic structure elements such as MgAl₂O₄.

Due to the structure of outer porous ceramic layers, the typical color is grey-white after the process of MAPET. FIG. 5 is to illustrate the appearance of this multi layers structure diaphragm.

The thickness of ceramic layers combining a thin barrier layer, a slightly porous oxide ceramic layer and a highly porous oxide ceramic layer is determined by the reacting time in the treatment process and usually in the range from 5 to 25 micron The thickness shall be in line with the function purpose of loudspeaker diaphragm considering the optimal combination of two characteristics—stiffness and mechanical internal loss properties.

As will be understood from the above, the loudspeaker diaphragm according to the present invention utilize the advantage of mechanical internal loss property from magnesium base alloy and also further improve the stiffness by the addition of oxide ceramic layers. The present invention also resolves the environment reliability issue, that magnesium is vulnerable to the environment. This issue is also an important considered design factor for commercializing a new material for the application of the loudspeaker diaphragm.

In summation of the description above, the present invention definitely can overcome the shortcomings of the prior-art assembly and applications, and enhances the performance than the conventional structure and further complies with the patent application requirements and is submitted to the Patent and Trademark Office for review and granting of the commensurate patent rights.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A loudspeaker diaphragm comprising a magnesium base alloy as a substrate and multi-layers ceramic structure

2. A loudspeaker diaphragm as claimed in claim 1, wherein said the content of magnesium in alloy is over than 90%

3. A loudspeaker diaphragm as claimed in claim 1, wherein said the thickness of porous ceramic layers is between 5 to 25 micron to provide the protection function for magnesium base alloy substrate and enhance the stiffness of the diaphragm.
